(19) United States
(12) Patent Application Publication
(10) Pub. No.: US 2023/0055134 A1
(43) Pub. Date: Feb. 23, 2023

(54) TOLERANCE RING FOR DRIVE MOTOR STATOR

(71) Applicant: SAINT-GOBAIN PERFORMANCE PLASTICS RENCOL LIMITED, Coventry (GB)

(72) Inventors: Thomas CHILDS, Bristol (GB); Andrew BROADWELL, Monmouth (GB); Thomas FRANCIS, Bristol (GB); Martin SCHWIEGEL, Cologne (DE)

(21) Appl. No.: 17/819,962

(22) Filed: Aug. 16, 2022

Related U.S. Application Data
(60) Provisional application No. 63/260,361, filed on Aug. 18, 2021.

(51) Int. Cl. H02K 9/00; H02K 5/04

(52) U.S. Cl. CPC H02K 9/00; H02K 5/04

(57) ABSTRACT

Systems and methods include providing a tolerance ring in an electric drive motor assembly having a housing and a stator disposed within the housing. The tolerance ring is disposed within the housing and retains or secures the stator within the housing and control movement of the stator within the housing. The tolerance ring includes an annular ring-shaped substrate formed from a metallic material and a plurality of projections protruding radially inward from an inner surface of the substrate or radially outward from an outer surface of the substrate. The tolerance ring optionally includes one or more cooling features formed in the substrate and configured to promote cooling between a fluid disposed in the housing and the stator.

### CROSS-REFERENCE TO RELATED APPLICATION(S)

This application claims priority under 35 U.S.C. § 119(e) to U.S. Provisional Application No. 63/260,361, entitled “TOLERANCE RING FOR DRIVE MOTOR STATOR,” by Thomas CHILDS et al., filed Aug. 18, 2021, which is assigned to the current assignee hereof and incorporated herein by reference in its entirety.

### BACKGROUND OF THE INVENTION

Electric drive motors are commonly used in a wide variety of industries. The use of electric drive motor technology in electric vehicle applications continues to advance is becoming more commonplace. Electric drive motors used in such electric vehicle applications operate on high voltage that is used to generate sufficient torque to power the drive train of the vehicle. Because of these demands on electric drive motors, the drive stators often require a secure mounting platform and may require cooling to operate efficiently and reliably. However, common methods of mounting the drive stators, such as the use of metallic fasteners, can cause magnetic deterioration and hinder performance of the drive stator. Accordingly, the industry continues to demand improvements in technology for such electric drive motor applications.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is an orthogonal top view of a tolerance ring according to an embodiment of the disclosure.

FIG. 2 is a partial oblique view of a tolerance ring according to an embodiment of the disclosure.

FIG. 3 is an orthogonal top view of a tolerance ring according to an embodiment of the disclosure.

FIG. 4 is an oblique view of a tolerance ring according to an embodiment of the disclosure.

FIG. 5 is a partial cross-sectional view of an assembly comprising a tolerance ring according to an embodiment of the disclosure.

FIG. 6 shows a partial cross-sectional side view of a housing of an assembly according to an embodiment of the disclosure.

FIG. 7 shows a partial oblique view of an assembly comprising one or more tolerance rings according to an embodiment of the disclosure.

The use of the same reference symbols in different drawings indicates similar or identical items.

### DETAILED DESCRIPTION

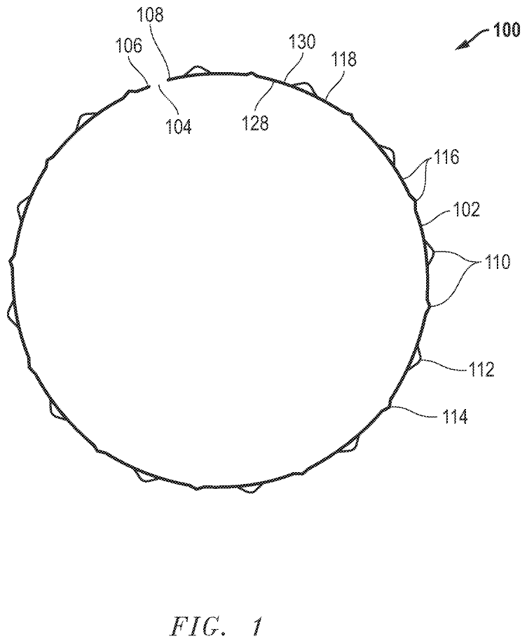

FIG. 1 shows an orthogonal top view of a tolerance ring 100 according to an embodiment of the disclosure. The tolerance ring 100 may generally comprise an annular band of material or a substrate 102 formed into an annular ring shape. In some embodiments, the tolerance ring 100 may comprise a solid ring having a gap 104 defining a first circumferential end 106 and a second circumferential end 108 of the substrate 102. In some embodiments, the substrate 102 may be formed from a resilient metallic material. In some embodiments, the metallic material of the substrate 102 may comprises a non-magnetic material, such as stainless steel. In some embodiments, the metallic material may comprise aluminum, beryllium, bronze, copper, iron, magnesium, spring steel, stainless steel, tin, titanium, tungsten, or an alloy thereof.

The tolerance ring 100 may comprise a plurality of projections 110 (e.g., waves 112, fingers 114, or a combination thereof) formed in and disposed circumferentially about the substrate 102. In some embodiments, the tolerance ring 100 may comprise a non-sinusoidal profile. In some embodiments, the projections 110 may protrude radially inward from an inner surface 128 and/or radially outward from an outer surface 130 of the substrate 102. In some embodiments, the projections 110 may comprise the same geometric shape and/or size as compared to each other. In other embodiments, a number of projections 110 may have different geometric shapes and/or sizes as compared to each other. In yet other embodiments, all of the projections 110 may have different geometric shapes and/or sizes as compared to each other.

In some embodiments, the plurality of waves 112 may be disposed in one or more bands circumferentially about the tolerance ring 100. In some embodiments, the plurality of waves 112 may be grouped into a plurality of groups of waves 112. In some embodiments, each of the plurality of groups of waves 112 may comprise the same number of waves 112 per group. However, in some embodiments, at least one of the plurality of groups of waves 112 may comprise a different number of waves 112. In some embodiments, each of the plurality of groups of waves 112 may comprises at least 1, at least 2, at least 3, at least 4, or at least 5 waves per group. Further, in some embodiments, each of the plurality of groups of waves 212 may be divided by one or more fingers 114, one or more cooling features 116, or a combination thereof. It will be appreciated that the projections 110 (e.g., waves 112, fingers 114, or a combination thereof) may be selected to provide desired elastic/plastic deformation characteristics, desired force transfer properties, to account for manufacturing tolerances of hardware components, and/or to compensate for thermal expansion and wear that may occur between hardware components during operation.

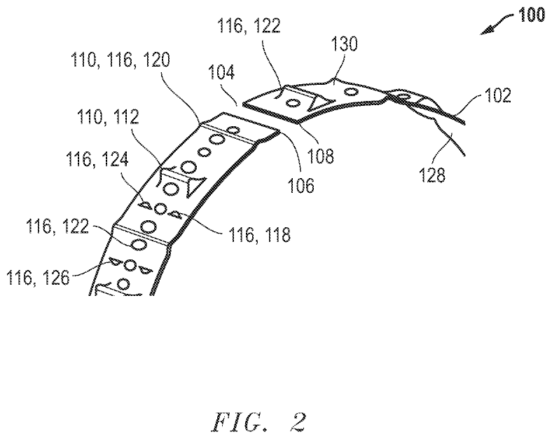

FIG. 2 shows a partial detailed oblique view of the tolerance ring 100 according to an embodiment of the disclosure. In some embodiments, the tolerance ring 100 may also comprise one or more cooling features 116 formed in the substrate 102 of the tolerance ring 100. In some embodiments, the tolerance ring 100 may comprise a plurality of cooling features 116 formed in the substrate 102 of the tolerance ring 100. As will be discussed later herein, the one or more cooling features 116 may generally be configured to allow a fluid to pass between the tolerance ring 100 and a housing 402 of an electric drive motor assembly 400, between the tolerance ring 100 and a stator 404 of the electric drive motor assembly 400, or a combination thereof to promote cooling of the stator 404.

In some embodiments, the one or more cooling features 116 may comprise a plurality of flat banded portions 118 disposed about the tolerance ring 100. In some embodiments, the flat banded portions 118 substantially abut a housing 402 of an electric drive motor assembly 400 to allow a fluid to pass between the flat banded portions 118 of the tolerance ring 100 and a stator 404 of the electric drive motor assembly 400. In some embodiments, the flat banded portions 118 may substantially abut the stator 404 of the electric drive motor assembly 400 to allow the fluid to pass between the flat banded portions 118 of the tolerance ring 100 and the housing 402 of the electric drive motor assembly 400 to promote cooling of the stator 404 of the electric drive motor assembly 400.

In some embodiments, the one or more cooling features 116 may comprise a plurality of cooling channels 120 disposed about the tolerance ring 100. In some embodiments, the plurality of cooling channels 120 may allow a fluid to pass between the flat banded portions 118 of the tolerance ring 100 and a housing 402, a stator 404, or a combination thereof of an electric drive motor assembly 400. In some embodiments, the plurality of cooling channels 120 may allow a fluid to pass between the cooling channels 120 of the tolerance ring 100 and the housing 402, the stator 404, or a combination thereof to promote cooling of the stator 404 of an electric drive motor assembly 400.

In some embodiments, the one or more cooling features 116 may comprise a plurality of apertures 122 formed in the substrate 102 of the tolerance ring 100. In some embodiments, the plurality of apertures 122 are disposed in the plurality of waves 112, the plurality of flat banded portions 118, the plurality of cooling channels 120, or a combination thereof. The apertures 122 may generally be configured to allow or promote flow of a fluid through the substrate 102 of the tolerance ring 100 to promote cooling of a stator 404 of an electric drive motor assembly 400.

Furthermore, in some embodiments, the tolerance ring 100 may comprise a plurality of raised portions 124 and/or dimples 126, or a combination thereof formed in the substrate 102 of the tolerance ring 100. In some embodiments, the raised portions 124 and/or dimples 126 may not extend across a width of the substrate 102, such as the fingers 114 and/or channels 120. In some embodiments, the raised portions 124 and/or dimples 126 may be substantially circular. It will be appreciated that the raised portions 124 may extend from the substrate 102 in the same direction as the waves 112, and the dimples 126 may extend from the substrate 102 in the opposing direction as the waves 112. Further, the raised portions 124 and/or dimples 126 may generally be configured to promote turbulent flow of a fluid about a stator 404 of an electric drive motor assembly 400.

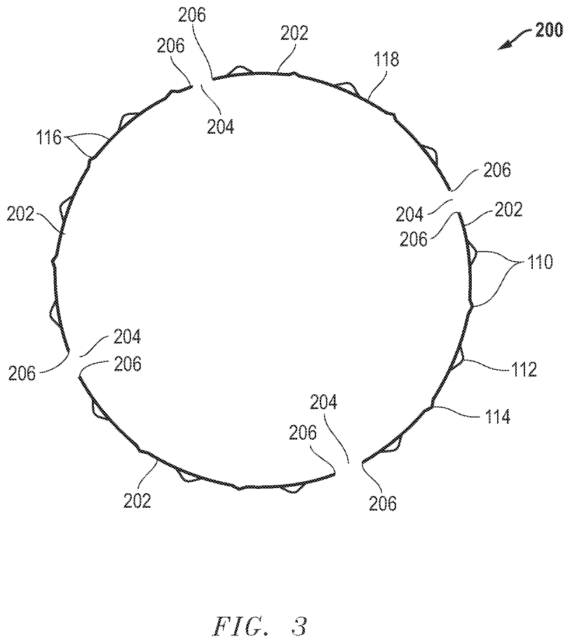

FIG. 3 is an orthogonal top view of a tolerance ring 200 according to an embodiment of the disclosure. In some embodiments, the tolerance ring 200 may be substantially similar to tolerance ring 100. However, the tolerance ring 200 comprises a plurality of segmented rings 202 (multi-band tolerance ring) comprising a gap 204 between each of the plurality of segmented rings 202, wherein each gap 204 defines an end 206 of adjacently disposed segmented rings 202. In some embodiments, the tolerance ring 100 may comprise at least 2 segments, at least 3 segments, or at least 4 segments. Further, when installed, the plurality of segmented rings 202 may be circumferentially aligned.

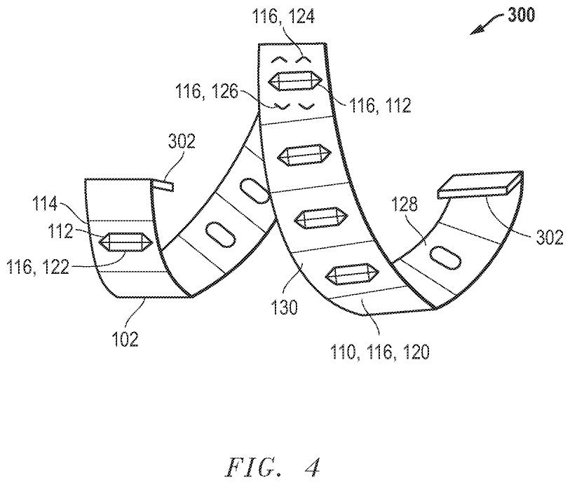

FIG. 4 is an oblique view of a tolerance ring 300 according to an embodiment of the disclosure. In some embodiments, the tolerance ring 300 may be substantially similar to tolerance ring 100 or 200. However, the tolerance ring 300 may comprise a spiral-shaped tolerance ring 300. In some embodiments, the tolerance ring 300 may comprise a locating feature 302 at one or more distal ends of the spiral-shaped tolerance ring 300. In some embodiments, the locating features 302 may be configured to lock in one or more axial cooling channels 408 formed in an electric drive motor stator 404 of an electric drive motor assembly 400, which may prevent rotation of the tolerance ring 300 with respect to the stator 404. Further, in some embodiments, the tolerance ring 300 may comprise a beading 304 (e.g., metallic, polymeric, or rubber) configured to guide a fluid around the stator 404 to enhance cooling of the stator 404 of the electric drive motor assembly 400.

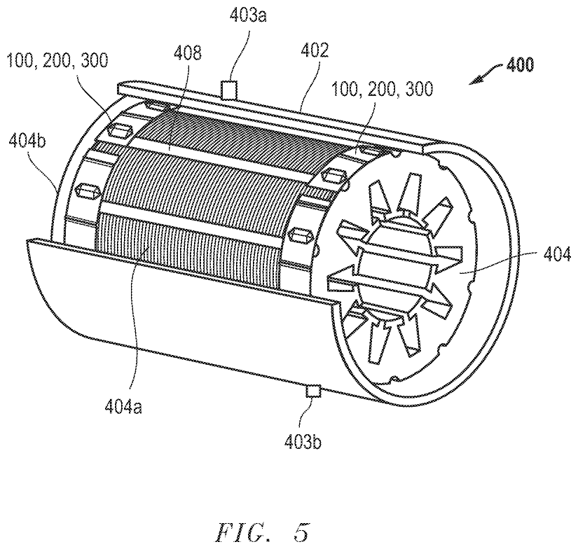

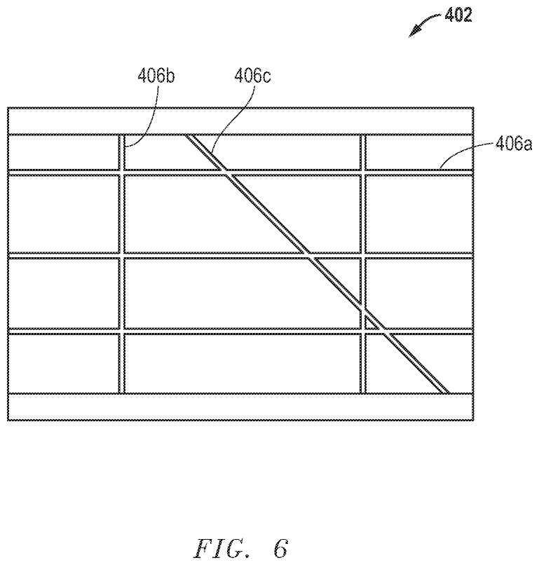

FIG. 5 shows a partial oblique view of an assembly 400 comprising one or more tolerance rings 100, 200, 300 according to an embodiment of the disclosure. In some embodiments, the assembly 400 comprises an electric drive motor assembly. The assembly 400 may generally comprise an outer component 402 and an inner component 404. In some embodiments, the outer component 402 may comprise a housing. In some embodiments, the housing 402 may be formed from aluminum, steel, stainless steel, titanium, or an alloy thereof. In some embodiments, the housing 402 may comprise one or more inlets 403a and one or more outlets 403b. FIG. 6 shows a partial cross-sectional side view of the housing 402 according to an embodiment of the disclosure. As shown in FIG. 6, in some embodiments, the housing 402 may comprise one or more axial channels 406a, one or more circumferential channels 406b, one or more helical or spiral channels 406c, or a combination thereof.

In some embodiments, the inner component 404 may be an electric drive motor stator. In some embodiments, the stator 404 may be formed from multiple metallic sheets of aluminum, steel, stainless steel, titanium, or an alloy thereof that are glued or welded together. In some embodiments, the stator 404 may be substantially round. However, in some embodiments, the stator 404 may not be perfectly round due to the construction of the stator 404. In some embodiments, one or more axial channels 408 may be formed in the stator 404 and divide the stator 404 into stator segments. In some embodiments, each group of a plurality of groups of waves 112 may be aligned with a stator segment. Further, in some embodiments, the one or more cooling features 116 may be aligned with the one or more axial channels 408 formed in the stator 404. In some embodiments, this may further enhance cooling of the stator 404 by maximizing the cross-sectional area of fluid passages formed between the one or more tolerance rings 100, 200, 300 and the stator 404 and/or the housing 402. In some embodiments, it will be appreciated that the plurality of waves 112 may not form fluid flow passages through the tolerance ring 100, the plurality of cooling features 116 may not be configured to secure of retain the stator 404 in the housing 402 of the assembly 400, or a combination thereof.

In some embodiments, the stator 404 may comprise an electrical portion 404a and a non-electrical portion 404b. In some embodiments, the electrical portion 404a of the stator 404 may be formed from a plurality of laminated metallic sheets, and the one or more tolerance rings 100, 200, 300 may be disposed about the electrical portion 404a of the stator 404. However, in some embodiments, the one or more tolerance rings 100, 200, 300 may be disposed about the non-electrical portion 404b of the stator 404. In some embodiments, disposing the one or more tolerance rings 100, 200, 300 about the non-electrical portion 404b may further deter or altogether prevent magnetic deterioration and/or line welding fixation of the stator 404 generally caused by traditional methods (e.g., fasteners) of mounting a stator 404 in the housing 402. It will be appreciated that the stator 404 may be sized appropriately depending on the application, such as a small electric motor or a vehicle drive motor. Thus, the stator 404 may comprise a diameter of at least 25 mm to not greater than 500 mm.

The one or more tolerance rings 100, 200, 300 may generally be disposed within the housing 402 and configured to retain or secure the stator 404 within the housing 402. The one or more tolerance rings 100, 200, 300 may also be configured to generate a retention force within the housing 402 to control movement of the stator 404 within the housing 402. In some embodiments, the one or more tolerance rings 100, 200, 300 may be configured to generate a higher retention force when heated. As stated, the one or more tolerance rings 100, 200, 300 may generally be formed from a metallic material comprising a non-magnetic material, such as stainless steel. The one or more tolerance rings 100, 200, 300 may generally be resilient and form to the outer profile of the stator 404. The one or more tolerance rings 100, 200, 300 may retain the substantially round shape of the stator 404 and prevent magnetic deterioration and/or line welding fixation of the stator 404 caused by traditional methods (e.g., fasteners) of mounting a stator 404 in the housing 402. Thus, in some embodiments, utilization of the one or more tolerance rings 100, 200, 300 may foster ideal magnetic behavior of the stator 404, thereby increasing performance of electric drive motor assembly 400.

In some embodiments, the one or more tolerance rings 100, 200, 300 may comprise a single tolerance ring 100, 200, 300. In some embodiments, the single tolerance ring 100, 200, 300 may be disposed at a rear of the housing 02 and/or stator 404. In some embodiments, the single tolerance ring 100, 200, 300 may be disposed at a front of the housing 402 and/or stator 404. In some embodiments, the single tolerance ring 100, 200, 300 may be disposed along an axial length of the housing 402 and/or stator 404 away from a rear and a front of the housing 402 or stator 404. In some embodiments, the one or more tolerance rings 100, 200, 300 may comprise a plurality of tolerance rings. In some embodiments, the plurality of tolerance rings 100, 200, 300 may comprise at least 2, at least 3, at least 4, at least 5, or at least 6 tolerance rings 100, 200, 300. In some embodiments, the plurality of tolerance rings 100, 200, 300 may be substantially similar. In other embodiments, the plurality of tolerance rings 100, 200, 300 may be different. Accordingly, the assembly 100 may comprise any number and/or combination of tolerance rings 100, 200, 300 to secure the stator 404 within the housing 100. Further, the one or more tolerance rings 100, 200, 300 may extend along a beneficial axial length of the stator 404. Accordingly, in some embodiments the one or more tolerance rings 100, 200, 300 may extend along at least 1%, at least 2%, at least 3%, at least 4%, at least 5%, at least 10%, or at least 15% of an axial length of the stator.

The one or more tolerance rings 100, 200, 300 may generally comprise a plurality of projections 110 (e.g., waves 112, fingers 114, or a combination thereof) formed in and disposed circumferentially about the substrate 102 of the one or more tolerance rings 100, 200, 300. In some embodiments, the plurality of waves 112, the plurality of fingers 114, or a combination thereof may protrude radially inward from the inner surface 128 of the tolerance ring 100, 200, 300 and be in contact with the stator 404. In some embodiments, the plurality of waves 112, the plurality of fingers 114, or a combination thereof may protrude radially outward from the outer surface 130 of the tolerance ring 100, 200, 300 and be in contact with the housing 402. In some embodiments, the plurality of waves 112 and/or fingers 114 may be configured to control movement of the stator 404 within the housing 402. In some embodiments, the plurality of waves 112 and/or fingers 114 may be configured to generate a retention force and/or be preloaded within the housing 402 to control movement of the stator 404 within the housing 402.

In some embodiments comprising a plurality of tolerance rings 100, 200, 300, the plurality of projections 110 (e.g., waves 112, fingers 114, or a combination thereof) on one or more tolerance rings 100, 200, 300 may be offset circumferentially with respect to the plurality of the projections of an adjacent tolerance ring 100, 200, 300. In some embodiments, the plurality of projections 110 (e.g., waves 112, fingers 114, or a combination thereof) on one or more tolerance rings 100, 200, 300 may protrude radially inward from the inner surface 128 of the substrate 102 of the tolerance ring 100, 200, 300, while the plurality of projections 110 (e.g., waves 112, fingers 114, or a combination thereof) on another tolerance ring 100, 200, 300 may protruding radially outward from the outer surface 130 of the substrate 102 of the tolerance ring 100, 200, 300. In some embodiments, the tolerance ring 100, 200, 300 comprising the plurality of projections 110 (e.g., waves 112, fingers 114, or a combination thereof) protruding radially inward from the inner surface 128 of the substrate 102 may be disposed at a rear of the stator 402, while the tolerance ring 100, 200, 300 comprising the plurality of projections 110 (e.g., waves 112, fingers 114, or a combination thereof) protruding radially outward from the outer surface 130 of the substrate 102 may be disposed at a front of the stator 404.

The one or more tolerance rings 100, 200, 300 may generally comprise one or more cooling features 116 (e.g., flat banded portions 118, channels 120, apertures 122, raised portions 124, dimples 126, etc.) formed in the substrate 102 of the tolerance ring 100, 200, 300. The one or more cooling features 116 may generally be configured to allow a fluid to pass between the tolerance ring 100 and the housing 402 of the assembly 400, between the tolerance ring 100 and the stator 404 of the assembly 400, or a combination thereof to promote cooling of the stator 404.

In some embodiments, the one or more cooling features 116 may comprise a plurality of flat banded portions 118 disposed about the tolerance ring 100. In some embodiments, the flat banded portions 118 substantially abut the housing 402 to allow a fluid to pass between the flat banded portions 118 of the tolerance ring 100 and the stator 404 of the assembly 400. In some embodiments, the flat banded portions 118 may substantially abut the stator 404 to allow the fluid to pass between the flat banded portions 118 of the tolerance ring 100 and the housing 402 of the assembly 400.

In some embodiments, the one or more cooling features 116 may comprise a plurality of cooling channels 120 disposed about the tolerance ring 100. In some embodiments, the plurality of cooling channels 120 may allow a fluid to pass between the flat banded portions 118 of the tolerance ring 100 and the housing 402, the stator 404, or a combination thereof of the assembly 400. In some embodiments, the plurality of cooling channels 120 may allow a fluid to pass between the cooling channels 120 of the tolerance ring 100 and the housing 402, the stator 404, or a combination thereof of the assembly 400.

In some embodiments, the one or more cooling features 116 may comprise a plurality of apertures 122 formed in the substrate 102 of the tolerance ring 100. In some embodiments, the plurality of apertures 122 may be disposed in the plurality of waves 112, the plurality of flat banded portions 118, the plurality of cooling channels 120, or a combination thereof. The apertures 122 may generally be configured to allow or promote flow of a fluid through the substrate 102 of the tolerance ring 100 to promote cooling of a stator 404 of the assembly 400.

Furthermore, in some embodiments, the tolerance ring 100 may comprise a plurality of raised portions 124 and/or dimples 126, or a combination thereof formed in the substrate 102 of the tolerance ring 100. In some embodiments, the raised portions 124 and/or dimples 126 may not extend across a width of the substrate 102, such as the fingers 114 and/or channels 120. In some embodiments, the raised portions 124 and/or dimples 126 may be substantially circular. It will be appreciated that the raised portions 124 may extend from the substrate 102 in the same direction as the waves 112, and the dimples 126 may extend from the substrate 102 in the opposing direction as the waves 112. Further, the raised portions 124 and/or dimples 126 may generally be configured to promote turbulent flow of a fluid about the stator 404 to promote cooling of the stator 404 of the assembly 400.

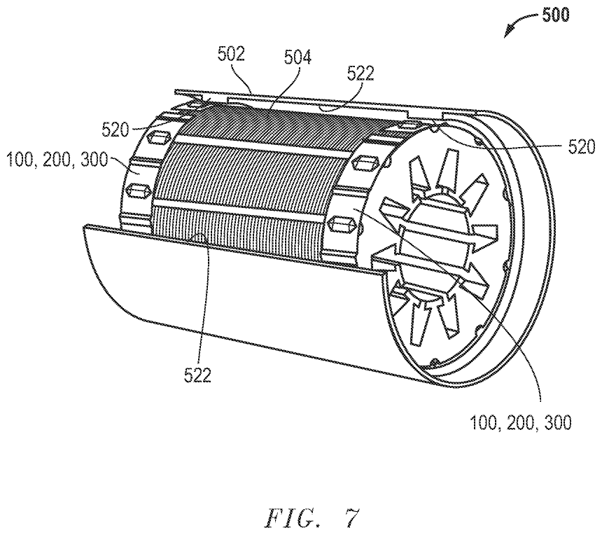

FIG. 7 shows a partial oblique view of an assembly 500 comprising one or more tolerance rings 100, 200, 300 according to an embodiment of the disclosure. As shown in FIGS. 5 and 6, in some embodiments, the housing 402 may comprise a substantially constant diameter. As shown in FIG. 7, in some embodiments, the housing 502 may comprise one or more reduced diameter portions 520 radially adjacent to the one or more tolerance rings 100, 200, 300. In such embodiments, the housing 502 may comprise one or more enlarged diameter portions 522 that are not radially adjacent to the one or more tolerance rings 100, 200, 300. This may, at least in some embodiments, increase a cooling capacity of the housing 502 and/or increase a fluid capacity of the fluid carried within the housing 502 to further promote cooling of the stator 504.

Embodiments of a tolerance ring 100, 200, 300 and/or an electric drive motor assembly 400, 500 may include one or more of the following:

Embodiment 1. A tolerance ring, comprising: an annular ring-shaped substrate formed from a metallic material; a plurality of projections protruding radially inward from an inner surface of the substrate or radially outward from an outer surface of the substrate; and one or more cooling features formed in the substrate.

Embodiment 2. The tolerance ring of embodiment 1, wherein the metallic material of the substrate comprises a non-magnetic material, such as stainless steel.

Embodiment 3. The tolerance ring of any one of embodiments 1 to 2, wherein the tolerance ring comprises a solid ring having a gap defining circumferential ends of the substrate.

Embodiment 4. The tolerance ring of any one of embodiments 1 to 2, wherein the tolerance ring comprises a plurality of segmented rings (multi-band tolerance ring) comprising a gap between each of the plurality of segmented rings, wherein each gap defines an end of adjacently disposed segmented rings.

Embodiment 5. The tolerance ring of embodiment 4, wherein the plurality of segmented rings comprises at least 2 segments, at least 3 segments, or at least 4 segments.

Embodiment 6. The tolerance ring of any one of embodiments 4 to 5, wherein the plurality of segmented rings are circumferentially aligned.

Embodiment 7. The tolerance ring of any one of embodiments 1 to 2, wherein the tolerance ring comprises a spiral-shaped tolerance ring.

Embodiment 8. The tolerance ring of embodiment 7, wherein the tolerance ring comprises a locating feature at one or more distal ends of the spiral-shaped tolerance ring.

Embodiment 9. The tolerance ring of embodiment 8, wherein the locating features are configured to lock in one or more cooling channels formed in an electric drive motor stator of an electric drive motor assembly.

Embodiment 10. The tolerance ring of embodiment 9, wherein the locating features prevent rotation of the tolerance ring with respect to the stator.

Embodiment 11. The tolerance ring of any one of embodiments 7 to 10, wherein the tolerance ring comprises a beading configured to guide a fluid around the stator.

Embodiment 12. The tolerance ring of any one of embodiments 1 to 11, wherein the plurality of projections comprises a plurality of waves.

Embodiment 13. The tolerance ring of embodiment 12, wherein the plurality of waves protrude radially inward from the inner surface of the substrate.

Embodiment 14. The tolerance ring of embodiment 12, wherein the plurality of waves protrude radially outward from the outer surface of the substrate.

Embodiment 15. The tolerance ring of any one of embodiments 12 to 14, wherein the plurality of waves are disposed in one or more bands about the circumference of the tolerance ring.

Embodiment 16. The tolerance ring of any one of embodiments 12 to 15, wherein the plurality of waves are grouped into a plurality of groups of waves.

Embodiment 17. The tolerance ring of embodiment 16, wherein each group of the plurality of waves are divided circumferentially by at least one of the one or more cooling features.

Embodiment 18. The tolerance ring of embodiment 17, wherein each group of the plurality of waves is aligned with a stator segment of a stator of an electric drive assembly, and wherein the one or more cooling features are aligned with channels formed in the stator that divide adjacent stator segments.

Embodiment 19. The tolerance ring of any one of embodiments 12 to 18, wherein the plurality of waves do not form flow passages through the tolerance ring, wherein the plurality of cooling features are not configured to secure of retain the stator in the housing of the electric drive motor assembly, or a combination thereof.

Embodiment 20. The tolerance ring of any one of embodiments 1 to 19, wherein the at least one tolerance ring is configured to be disposed within a housing of an electric drive motor assembly and retain or secure a drive motor stator of the electric drive motor assembly within the housing.

Embodiment 21. The tolerance ring of embodiment 20, wherein the drive motor stator comprises an electrical portion formed from a plurality of laminated metallic sheets, and wherein the at least one tolerance ring is configured to be disposed about the electrical portion of the stator.

Embodiment 22. The tolerance ring of embodiment 20, wherein the drive motor stator comprises a non-electrical portion, and wherein the at least one tolerance ring is configured to be disposed about the non-electrical portion of the stator.

Embodiment 23. The tolerance ring of any one of embodiments 20 to 22, wherein the one or more cooling features are configured to allow a fluid to pass between the tolerance ring and the housing of the electric drive motor assembly, between the tolerance ring and the stator of the electric drive motor assembly, or a combination thereof.

Embodiment 24. The tolerance ring of any one of embodiments 1 to 23, wherein the one or more cooling features comprises a plurality of flat banded portions disposed about the tolerance ring.

Embodiment 25. The tolerance ring of embodiment 24, wherein the flat banded portions substantially abut the housing of the electric drive motor assembly to allow the fluid to pass between the flat banded portions of the tolerance ring and the stator of the electric drive motor assembly.

Embodiment 26. The tolerance ring of any one of embodiments 24 to 25, wherein the flat banded portions substantially abut the stator of the electric drive motor assembly to allow the fluid to pass between the flat banded portions of the tolerance ring and the housing of the electric drive motor assembly.

Embodiment 27. The tolerance ring of any one of embodiments 1 to 26, wherein the one or more cooling features comprises a plurality of cooling channels disposed about the tolerance ring.

Embodiment 28. The tolerance ring of embodiment 27, wherein the cooling channels allow the fluid to pass between the flat banded portions of the tolerance ring and the housing, the stator, or a combination thereof of the electric drive motor assembly.

Embodiment 29. The tolerance ring of any one of embodiments 1 to 26, wherein the one or more cooling features comprises a plurality of apertures formed in the substrate of the tolerance ring.

Embodiment 30. The tolerance ring of embodiment 29, wherein the plurality of apertures are disposed in the plurality of waves, the plurality of flat banded portions, the plurality of cooling channels, or a combination thereof.

Embodiment 31. The tolerance ring of any one of embodiments 1 to 30, further comprising: a plurality of dimples, a plurality of raised portions, or a combination thereof formed in the substrate.

Embodiment 32. The tolerance ring of embodiment 31, wherein the plurality of dimples, the plurality of raised portions, or the combination thereof are configured to promote turbulent flow of a fluid about the stator of the electric drive motor assembly.

Embodiment 33. An electric drive motor assembly, comprising: an outer component comprising a housing; an inner component comprising a stator; and at least one tolerance ring disposed within the housing and configured to retain or secure the stator within the housing, wherein the at least one tolerance ring comprises: an annular ring-shaped substrate formed from a metallic material; a plurality of projections protruding radially inward from an inner surface of the substrate or radially outward from an outer surface of the substrate; and one or more cooling features formed in the substrate.

Embodiment 34. The assembly of embodiment 33, wherein the metallic material of the substrate comprises a non-magnetic material, such as stainless steel.

Embodiment 35. The assembly of any one of embodiments 33 to 34, wherein the tolerance ring comprises a solid ring having a gap defining circumferential ends of the substrate.

Embodiment 36. The assembly of any one of embodiments 33 to 34, wherein the tolerance ring comprises a plurality of segmented rings (multi-band tolerance ring) comprising a gap between each of the plurality of segments, wherein each gap defines an end of adjacently disposed segmented rings.

Embodiment 37. The assembly of embodiment 36, wherein the plurality of segmented rings comprises at least 2 segments, at least 3 segments, or at least 4 segments.

Embodiment 38. The assembly of any one of embodiments 36 to 37, wherein the plurality of segmented rings are circumferentially aligned about the stator.

Embodiment 39. The assembly of any one of embodiments 33 to 34, wherein the tolerance ring comprises a spiral-shaped tolerance ring.

Embodiment 40. The assembly of embodiment 39, wherein the tolerance ring comprises a locating feature at one or more distal ends of the spiral-shaped tolerance ring.

Embodiment 41. The assembly of embodiment 40, wherein the locating features are configured to lock in one or more cooling channels formed in the stator of the assembly.

Embodiment 42. The assembly of embodiment 41, wherein the locating features prevent rotation of the tolerance ring with respect to the electric drive motor stator.

Embodiment 43. The assembly of any one of embodiments 39 to 42, wherein the tolerance ring comprises a beading configured to guide a fluid around the stator.

Embodiment 44. The assembly of any one of embodiments 33 to 43, wherein the plurality of projections comprises a plurality of waves.

Embodiment 45. The assembly of embodiment 44, wherein the plurality of waves protrude radially inward from the inner surface of the substrate.

Embodiment 46. The assembly of embodiment 44, wherein the plurality of waves protrude radially outward from the outer surface of the substrate.

Embodiment 47. The assembly of any one of embodiments 44 to 46, wherein the plurality of waves are disposed in one or more bands about the circumference of the tolerance ring.

Embodiment 48. The assembly of any one of embodiments 44 to 47, wherein the plurality of waves are grouped into a plurality of groups of waves.

Embodiment 49. The assembly of embodiment 48, wherein each group of the plurality of waves are divided circumferentially by at least one of the one or more cooling features.

Embodiment 50. The assembly of embodiment 49, wherein the stator comprises one or more axial channels that divide the stator into stator segments, wherein each group of the plurality of waves is aligned with a stator segment, and wherein the one or more cooling features are aligned with the axial channels.

Embodiment 51. The assembly of any one of embodiments 44 to 50, wherein the plurality of waves do not form flow passages through the tolerance ring, wherein the one or more cooling features are not configured to secure of retain the stator in the housing of the electric drive motor assembly, or a combination thereof.

Embodiment 52. The assembly of any one of embodiments 33 to 51, wherein the drive motor stator comprises an electrical portion formed from a plurality of laminated metallic sheets, and wherein the at least one tolerance ring is configured to be disposed about the electrical portion of the stator.

Embodiment 53. The assembly of any one of embodiments 33 to 51, wherein the drive motor stator comprises a non-electrical portion, and wherein the at least one tolerance ring is configured to be disposed about the non-electrical portion of the stator.

Embodiment 54. The assembly of any one of embodiments 33 to 53, wherein the one or more cooling features are configured to allow a fluid to pass between the tolerance ring and the housing of the electric drive motor assembly, between the tolerance ring and the stator of the electric drive motor assembly, or a combination thereof.

Embodiment 55. The assembly of any one of embodiments 33 to 54, wherein the one or more cooling features comprises a plurality of flat banded portions disposed about the tolerance ring.

Embodiment 56. The assembly of embodiment 55, wherein the flat banded portions substantially abut the housing of the electric drive motor assembly to allow the fluid to pass between the flat banded portions of the tolerance ring and the stator of the electric drive motor assembly.

Embodiment 57. The assembly of any one of embodiments 53 to 56, wherein the flat banded portions substantially abut the stator of the electric drive motor assembly to allow the fluid to pass between the flat banded portions of the tolerance ring and the housing of the electric drive motor assembly.

Embodiment 58. The assembly of any one of embodiments 33 to 57, wherein the one or more cooling features comprises a plurality of cooling channels disposed about the tolerance ring.

Embodiment 59. The assembly of embodiment 58, wherein the cooling channels allow the fluid to pass between the flat banded portions of the tolerance ring and the housing, the stator, or a combination thereof of the electric drive motor assembly.

Embodiment 60. The assembly of any one of embodiments 33 to 59, wherein the one or more cooling features comprises a plurality of apertures formed in the substrate of the tolerance ring.

Embodiment 61. The assembly of embodiment 60, wherein the plurality of apertures are disposed in the plurality of waves, the plurality of flat banded portions, the plurality of cooling channels, or a combination thereof.

Embodiment 62. The assembly of any one of embodiments 33 to 61, further comprising: a plurality of dimples, a plurality of raised portions, or a combination thereof formed in the substrate.

Embodiment 63. The assembly of embodiment 62, wherein the plurality of dimples, the plurality of raised portions, or the combination thereof are configured to promote turbulent flow of a fluid about the stator of the electric drive motor assembly.

Embodiment 64. The assembly of any one of embodiments 33 to 63, wherein the at least one tolerance ring is configured to control movement of the stator within the housing.

Embodiment 65. The assembly of embodiment 64, wherein the at least one tolerance ring is configured to generate a retention force within the housing to control movement of the stator within the housing.

Embodiment 66. The assembly of embodiment 65, wherein the at least one tolerance ring is configured to generate a higher retention force when heated.

Embodiment 67. The assembly of any one of embodiments 33 to 66, wherein the at least one tolerance ring comprises a single tolerance ring.

Embodiment 68. The assembly of embodiment 67, wherein the single tolerance ring is disposed at a rear of the housing or stator.

Embodiment 69. The assembly of embodiment 67, wherein the single tolerance ring is disposed at a front of the housing or stator.

Embodiment 70. The assembly of embodiment 67, wherein the single tolerance ring is disposed along an axial length of the stator away from a rear and a front of the housing or stator.

Embodiment 71. The assembly of any one of embodiments 33 to 66, wherein the at least one tolerance ring comprises a plurality of tolerance rings.

Embodiment 72. The assembly of embodiment 71, wherein the plurality of tolerance rings comprises at least 2, at least 3, at least 4, at least 5, or at least 6 tolerance rings.

Embodiment 73. The assembly of any one of embodiments 69 to 72, wherein the plurality of tolerance rings are substantially similar.

Embodiment 74. The assembly of any one of embodiments 69 to 72, wherein the plurality of tolerance rings are different.

Embodiment 75. The assembly of any one of embodiments 69 to 74, wherein the plurality of tolerance rings extend along at least 1%, at least 2%, at least 3%, at least 4%, at least 5%, at least 10%, or at least 15% of an axial length of the stator.

Embodiment 76. The assembly of any one of embodiments 69 to 75, wherein the plurality of the projections on each of the plurality of tolerance rings are offset circumferentially with respect to the plurality of the projections of an adjacent tolerance ring.

Embodiment 77. The assembly of any one of embodiments 69 to 76, wherein at least one of the plurality of tolerance rings comprises the plurality of projections protruding radially inward from the inner surface of the substrate, and wherein at least one of the plurality of tolerance rings comprises the plurality of projections protruding radially outward from the outer surface of the substrate.

Embodiment 78. The assembly of embodiment 77, wherein the at least one of the plurality of tolerance rings comprising the plurality of projections protruding radially inward from the inner surface of the substrate is disposed at a rear of the stator, and wherein the at least one of the plurality of tolerance rings comprising the plurality of projections protruding radially outward from the outer surface of the substrate is disposed at a front of the stator.

Embodiment 79. The assembly of any one of embodiments 33 to 78, wherein the housing is formed from aluminum steel, stainless steel, titanium, or an alloy thereof.

Embodiment 80. The assembly of any one of embodiments 33 to 79, wherein the housing comprises one or more inlets and one or more outlets.

Embodiment 81. The assembly of any one of embodiments 33 to 80, wherein the housing comprises one or more axial channels.

Embodiment 82. The assembly of any one of embodiments 33 to 81, wherein the housing comprises one or more circumferential channels.

Embodiment 83. The assembly of any one of embodiments 33 to 82, wherein the housing comprises one or more helical or spiral channels.

Embodiment 84. The assembly of any one of embodiments 33 to 83, wherein the housing comprises one or more reduced diameter portions radially adjacent to the at least one tolerance ring.

Embodiment 85. The assembly of any one of embodiments 33 to 84, wherein the housing comprises one or more enlarged diameter portions that are not radially adjacent to the at least one tolerance ring.

Embodiment 86. The assembly of any one of embodiments 33 to 85, wherein the stator comprises a diameter of at least 25 mm to not greater than 500 mm.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tolerance ring, comprising:
an annular ring-shaped substrate formed from a metallic material;
a plurality of projections protruding radially inward from an inner surface of the substrate or radially outward from an outer surface of the substrate; and
one or more cooling features formed in the substrate.

2. The tolerance ring of claim 1, wherein the tolerance ring comprises a plurality of segmented rings comprising a gap between each of the plurality of segmented rings, wherein each gap defines an end of adjacently disposed segmented rings.

3. The tolerance ring of claim 1, wherein the tolerance ring comprises a spiral-shaped tolerance ring.

4. The tolerance ring of claim 3, wherein the tolerance ring comprises a locating feature at one or more distal ends of the spiral-shaped tolerance ring.

5. The tolerance ring of claim 4, wherein the locating features are configured to lock in one or more cooling channels formed in an electric drive motor stator of an electric drive motor assembly.

6. The tolerance ring of claim 1, wherein the tolerance ring comprises at least one locating feature that prevents rotation of the tolerance ring with respect to the stator.

7. The tolerance ring of claim 1, wherein the tolerance ring comprises a beading configured to guide a fluid around the stator.

8. The tolerance ring of claim 1, wherein the plurality of projections comprises a plurality of waves grouped into a plurality of groups of waves, wherein the stator comprises a plurality of stator teeth, and wherein the number of projections is equal to or a multiple of the number of stator teeth.

9. The tolerance ring of claim 8, wherein each group of the plurality of waves are divided circumferentially by at least one of the one or more cooling features.

10. The tolerance ring of claim 9, wherein each group of the plurality of waves is aligned with a stator segment of a stator of an electric drive assembly, and wherein the one or more cooling features are aligned with channels formed in the stator that divide adjacent stator segments.

11. The tolerance ring of claim 8, wherein the plurality of waves do not form flow passages through the tolerance ring, wherein the plurality of cooling features are not configured to secure or retain the stator in the housing of the electric drive motor assembly, or a combination thereof.

12. The tolerance ring of claim 1, wherein the at least one tolerance ring is configured to be disposed within a housing of an electric drive motor assembly and retain or secure a drive motor stator of the electric drive motor assembly within the housing.

13. The tolerance ring of claim 1, wherein the one or more cooling features are configured to allow a fluid to pass between the tolerance ring and a housing of the electric drive motor assembly, between the tolerance ring and a stator of the electric drive motor assembly, or a combination thereof.

14. The tolerance ring of claim 1, wherein the one or more cooling features comprises a plurality of flat banded portions disposed about the tolerance ring.

15. The tolerance ring of claim 14, wherein the flat banded portions substantially abut the housing of the electric drive motor assembly to allow the fluid to pass between the flat banded portions of the tolerance ring and the stator of the electric drive motor assembly.

16. The tolerance ring of claim 14, wherein the flat banded portions substantially abut the stator of the electric drive motor assembly to allow the fluid to pass between the flat banded portions of the tolerance ring and the housing of the electric drive motor assembly.

17. The tolerance ring of claim 1, wherein the one or more cooling features comprises a plurality of cooling channels disposed about the tolerance ring.

18. The tolerance ring of claim 17, wherein the cooling channels allow the fluid to pass between the flat banded portions of the tolerance ring and the housing, the stator, or a combination thereof of the electric drive motor assembly.

19. The tolerance ring of claim 1, further comprising: a plurality of dimples, a plurality of raised portions, or a combination thereof formed in the substrate, wherein the plurality of dimples, the plurality of raised portions, or the combination thereof are configured to promote turbulent flow of a fluid about the stator of the electric drive motor assembly.

20. An electric drive motor assembly, comprising:
an outer component comprising a housing;
an inner component comprising a stator; and
at least one tolerance ring disposed within the housing and configured to retain or secure the stator within the housing, wherein the at least one tolerance ring comprises:
an annular ring-shaped substrate formed from a metallic material;
a plurality of projections protruding radially inward from an inner surface of the substrate or radially outward from an outer surface of the substrate; and
one or more cooling features formed in the substrate.
